(19) United States
(12) Patent Application Publication
(10) Pub. No.: US 2016/0061647 A1
(43) Pub. Date: Mar. 3, 2016

(54) WEIGHING AND TRACKING DEVICE

(71) Applicants: Jennifer McKinney, Las Vegas, NV (US); Robert Macias, Las Vegas, NV (US)

(72) Inventors: Jennifer McKinney, Las Vegas, NV (US); Robert Macias, Las Vegas, NV (US)

(21) Appl. No.: 14/694,370

(22) Filed: Apr. 23, 2015

Related U.S. Application Data
(60) Provisional application No. 62/070,437, filed on Aug. 26, 2014.

(51) Int. Cl. G01G 19/58; G01G 21/28; G01G 23/01

(52) U.S. Cl. CPC G01G 19/58; G01G 23/01; G01G 21/28

(57) ABSTRACT

A weighing and tracking device detachably joins with a container, such as luggage, for weighing and tracking. The capacity of the device to weigh the container helps determine weight compliance during travel. The capacity of the device to remain joined with the container enables tracking the container both indoors and outdoors. An elongated housing is sized to rest under a handle or slot in the container and enable lifting the container for weighing. A cap overlays the housing for protection. A central region is substantially where the weighing function occurs. A depression in the central region receives the handle to provide a balanced support for the container. A centered scale positions directly beneath the depression to absorb the weight of the container. A tracking unit uses GPS to track the container indoors or outdoors. This can be monitored on a communication device through a downloadable app.

### CROSS-REFERENCE TO RELATED APPLICATIONS

The present Utility patent application claims priority benefit of the U.S. provisional application for patent Ser. No. 62/070,437 filed on Aug. 26, 2014 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a weighing and tracking device that detachably joins with an object for weighing and tracking the object. More particularly, the invention relates to a weighing and tracking device that joins with luggage to support the weight of the luggage for determining weight and also tracking the luggage.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that luggage is used to contain articles of clothing and travel necessities. The luggage must often be weighed before boarding a vehicle to ensure weight compliance. Tracking the luggage is often necessary after arrival from travel.

A GPS tracking unit is a device that uses a Global Positioning System to determine the precise location of a vehicle, person, or other asset to which it is attached and to record the position of the asset at regular intervals. The recorded location data can be stored within the tracking unit, or it may be transmitted to a central location data base, or internet-connected computer, using a cellular, radio, or satellite modem embedded in the unit.

Typically, airlines scan bag tags to determine the location of the bag and match it up with the correct flight. However, one problem with this system is that it is dependent upon the workers' scanning each and every bag per flight, and this fails to occur far too often.

It is known that airlines and airports are very good about ensuring checked baggage makes it to the correct destination at the right time, however misplacement of luggage still occurs. Losses of luggage are not just not monetary, but also causes extreme inconvenience for the bag's owners, as well as aggravation, and the items lost may not be replaceable or may be needed for a business meeting. The owners of lost bags often need an immediate way to find them.

Typically, airlines have weight limits for checked bags. It's normal to see people at the check-in counter shuffling items from one suitcase to the other trying to get them under 50 lbs. This takes up time, prevents the airline from checking in other passengers as fast as they can, can be embarrassing for the person, and aggravating to the airline employee.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate perspective views of an exemplary weighing and tracking device weighing an exemplary container, where FIG. 1A illustrates the device being centered under a handle, and FIG. 1B illustrates a user lifting the container with the device, in accordance with an embodiment of the present invention;

FIG. 2 illustrates a perspective view of the weighing and tracking device being centered under a handle of the container, in accordance with an embodiment of the present invention;

FIGS. 3A, 3B, and 3C illustrate perspective views of an exemplary weighing and tracking device, where FIG. 3A illustrates a top angle perspective view of the device, an exemplary cap, and an exemplary power cable, FIG. 3B illustrates an elevated side view of the device, and FIG. 3C illustrates a top view of the device, in accordance with an embodiment of the present invention;

FIG. 4 illustrates a perspective view of the cap overlaying the weighing and tracking device to provide protection, in accordance with an embodiment of the present invention;

FIG. 5 illustrates a close-up view of an exemplary display portion displaying weight and an exemplary power switch, unit switch, and calibration switch, in accordance with an embodiment of the present invention;

FIG. 6 illustrates a close-up view of an exemplary device identification code being programmed into an exemplary communication device, in accordance with an embodiment of the present invention;

FIGS. 7A and 7B illustrate perspective views of the device tracking the container, where FIG. 7A illustrates an exemplary indoor tracking system, and FIG. 7B illustrates an exemplary outdoor tracking system, in accordance with an embodiment of the present invention; and

FIG. 8 illustrates a block diagram depicting an exemplary client/server system which may be used by an exemplary web-enabled/networked embodiment, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys. Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys. Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of weighing and tracking devices for objects that may be provided by preferred embodiments of the present invention. In one embodiment of the present invention, a weighing and tracking device detachably joins with a container to support the weight of the container to determine the weight of the container, and also track the container. In some embodiments, the container may include luggage. The capacity of the device to weigh the container may be efficacious for determining weight compliance during travel. Furthermore, the capacity of the device to remain joined with the container during travel may be effective for tracking the container both indoors and outdoors using a variety of tracking systems.

In some embodiments, the device may include an elongated housing that is sized and dimensioned to rest under a handle or slot in the container. The housing may include an outer surface and an interior region. The housing may also include a first end, a second end, and a centrally disposed central region. A cap may overlay the housing to provide protection against moisture and physical force.

In some embodiments, the central region is substantially where the weighing function occurs. A depression in the central region receives the handle or slot to provide a balanced support for the container. A centered scale may position in the interior region of the housing, directly beneath the depression, so as to absorb the full weight of the container. The centered, recessed scale ensures luggage handle is properly positioned on the scale during the weighing process to ensure proper weight display.

In one possible embodiment of use, the user may grasp the first and second ends of the housing and then slightly lift the container off the ground with their arms and legs. This type of lifting configuration ensure easier lifting in comparison to other luggage scales. Once the full weight of the container is on the depression, the scale registers the weight of the container. The weight displays on a display portion.

In some embodiments, either the first end or the second of the housing may include a power switch, a unit switch, and a calibration switch. The power switch powers the device for weighing and tracking functions. The unit switch converts between pounds and kilograms. The calibration switch zeroes the weight prior to lifting the container, serving as a reset, in essence. It is significant to note that the weight remains visible on the display portion until the calibration switch is depressed.

In one example, a digital readout of the weight displays on the display portion until the user hits the reset button. This ensures the user can read the weight after the container has been detached from the device during the weighing process. This is advantageous over prior art situations in which, once the weight of the container is removed from secondary scales, such as an airport scale, the weight display disappears, thereby making it difficult for a single user to weigh the container and read the weight at the same time. The device defeats that difficulty. One user can weigh the luggage, then set the luggage down and read the weight because it is still displayed until the user actuates the calibration switch to reset the weight to zero.

In some embodiments, a tracking unit may be disposed in the interior region of the housing. The tracking unit may include an apparatus that uses the Global Positioning System (GPS) to determine the precise location of the device, in which it is attached, and to record the position of the device at regular intervals. In this manner, the recorded location data can be stored within the tracking unit, or it may be transmitted to a central location data base, or internet-connected computer, using a cellular (GPRS or SMS), radio, or satellite modem embedded in the tracking unit.

Consequently, the location of the device, and consequently the container, may be displayed against a map backdrop either in real time, or when analyzing the track later, using GPS tracking software on a communication device. The device may utilize application software that is downloadable to a communication device, such as a smartphone. In some embodiments, the device may be tracked through both an indoor tracking system and an outdoor tracking system. In some embodiments, the device may include a unique device identification code that must be programmed into the software application app identification code. The device identification code ensures that the software application is only in communication with the user's actual device, or multiple devices, so as not to confuse tracking with other devices or tracking systems.

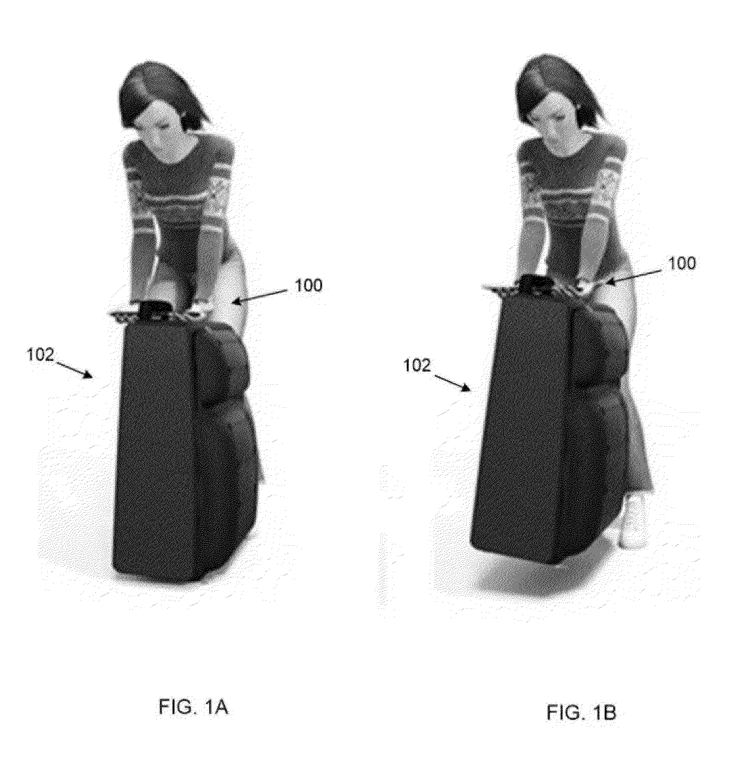

FIGS. 1A and 1B illustrate perspective views of an exemplary weighing and tracking device weighing an exemplary container, where FIG. 1A illustrates the device being centered under a handle, and FIG. 1B illustrates a user lifting the container with the device. In one aspect, a weighing and tracking device 100 detachably joins with a container 102 to support the weight of the container to determine weight and also tracks the container. In some embodiments, the container may include, without limitation, luggage, suitcases, travel bags, duffle bags, and pet cages. The capacity of the device to weigh the container may be efficacious for determining weight compliance during travel. Additionally, the capacity of the device to remain joined with the container during travel may be effective for tracking the container both indoors and outdoors using a variety of tracking systems.

In some embodiments, the device may include an elongated housing that is sized and dimensioned to rest under a handle or slot in the container. The housing may include an outer surface and an interior region. The housing may also include a first end, a second end, and a centrally disposed central region. In one possible embodiment of use, illustrated in FIGS. 1A and 1B, the user may grasp the first and second ends of the housing and then slightly lift the container off the ground with their arms and legs. This type of lifting configuration ensure easier lifting in comparison to other luggage scales. Once the full weight of the container is on the depression, the scale registers the weight of the container. The weight may then display on a display portion. The displayed weight remains displayed until the user resets the weight to zero.

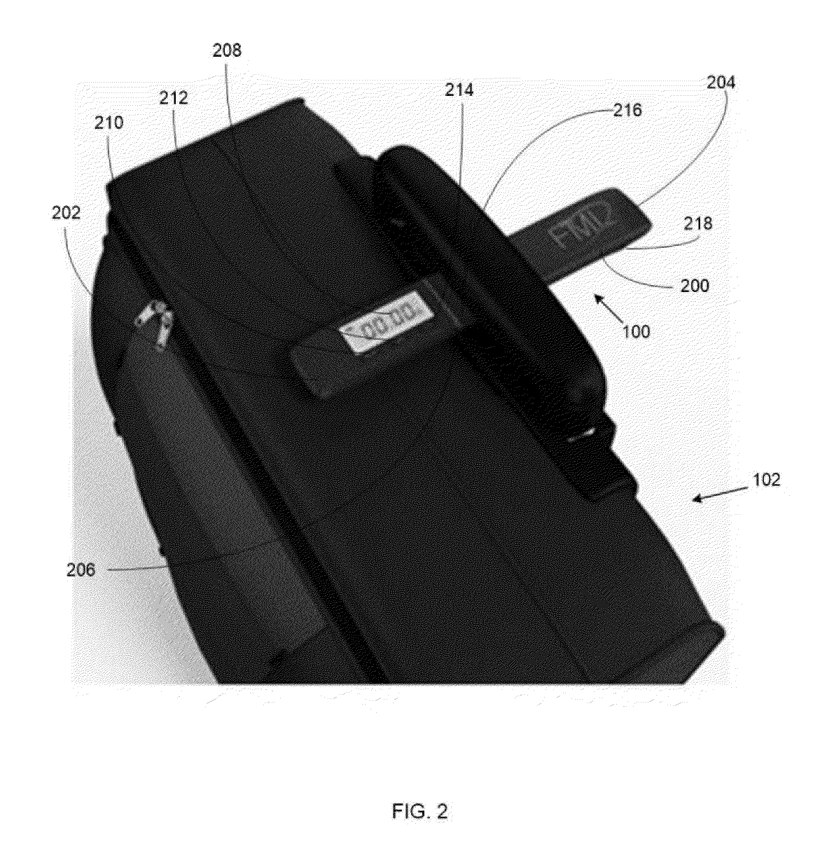

FIG. 2 illustrates a perspective view of the weighing and tracking device being centered under a handle of the container. In one aspect, the device may include an elongated housing 200 that is sized and dimensioned to rest under a handle or slot in the container. The housing may include an outer surface and an interior region. The housing may also include a first end 202, a second end 204, and a centrally disposed central region 206. A cap may overlay the housing to provide protection against moisture and physical force. The housing may be approximately 9″ long, 1.5″ wide and ½″ thick. The center region may include a depression that is about 2″ long and ¼″ deep for hosting a display portion. In one embodiment, a plurality of rubber feet on the housing may help provide grip for positioning inside the container.

In some embodiments, the central region is substantially where the weighing function occurs. A depression 216 in the central region receives the handle or slot to provide a balanced support for the container. A centered scale may position in the interior region of the housing, directly beneath the depression, so as to absorb the full weight of the container. The centered, recessed scale ensures luggage handle is properly positioned on the scale during the weighing process to ensure proper weight display. In one embodiment, the scale has a hundred and fifty pound weight capacity.

In some embodiments, either the first end or the second of the housing may include a power switch 210, a unit switch 212, and a calibration switch 214. The power switch powers the device for weighing and tracking functions. The unit switch converts between pounds and kilograms. The calibration switch zeroes the weight prior to lifting the container, serving as a reset, in essence. It is significant to note that the weight remains visible on a display portion 208 until the calibration switch is depressed. The housing may further include a port 218 that receives a power cord or a data cord. The port may include a socket for a USB jack.

In one example, a digital readout of the weight displays on a display portion until the user depresses a calibration switch to reset the weight to zero. This ensures the user can read the weight after the container has been detached from the device during the weighing process. This is advantageous over prior art situations in which, once the weight of the container is removed from secondary scales, such as an airport scale, the weight display disappears, thereby making it difficult for a single user to weigh the container and read the weight at the same time. The device defeats that difficulty. One user can weigh the luggage, then set the luggage down and read the weight because it is still displayed until the user actuates the calibration switch to reset the weight to zero.

In some embodiments, a tracking unit may be disposed in the interior region of the housing. The tracking unit may include an apparatus that uses a Global Positioning System (GPS) to determine the precise location of the device, in which it is attached, and to record the position of the device at regular intervals. In this manner, the recorded location data can be stored within the tracking unit, or it may be transmitted to a central location data base, or internet-connected computer, using a cellular (GPRS or SMS), radio, or satellite modem embedded in the tracking unit. Consequently, the location of the device, and consequently the container, may be displayed against a map backdrop either in real time, or when analyzing the track later, using GPS tracking software on a communication device. In one embodiment, a mobile application software program may be downloaded to transmit container location directly to a communication device used by the user, allowing them to keep track of its precise whereabouts.

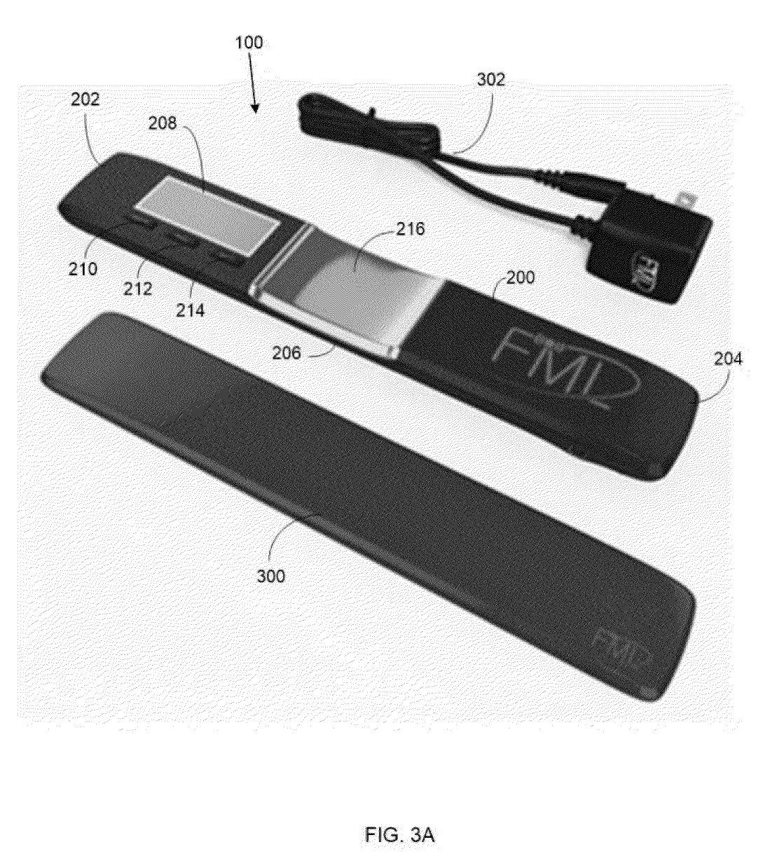

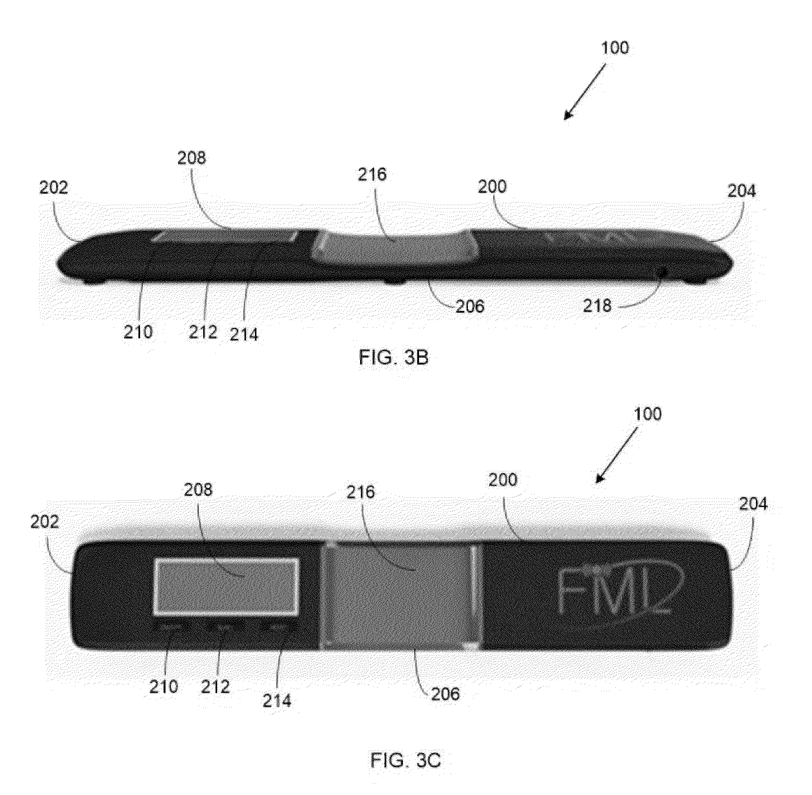

FIGS. 3A, 3B, and 3C illustrate perspective views of an exemplary weighing and tracking device, where FIG. 3A illustrates a top angle perspective view of the device, an exemplary cap, and an exemplary power cable, FIG. 3B illustrates an elevated side view of the device, and FIG. 3C illustrates a top view of the device. In one aspect, a cap 300 may overlay the housing to provide protection against moisture and physical force. The cap may help protect the device during transport. In some embodiments, a power cable 302 caries electricity to a rechargeable power source in the interior region of the device. The rechargeable power source may include a rechargeable battery or a solar panel.

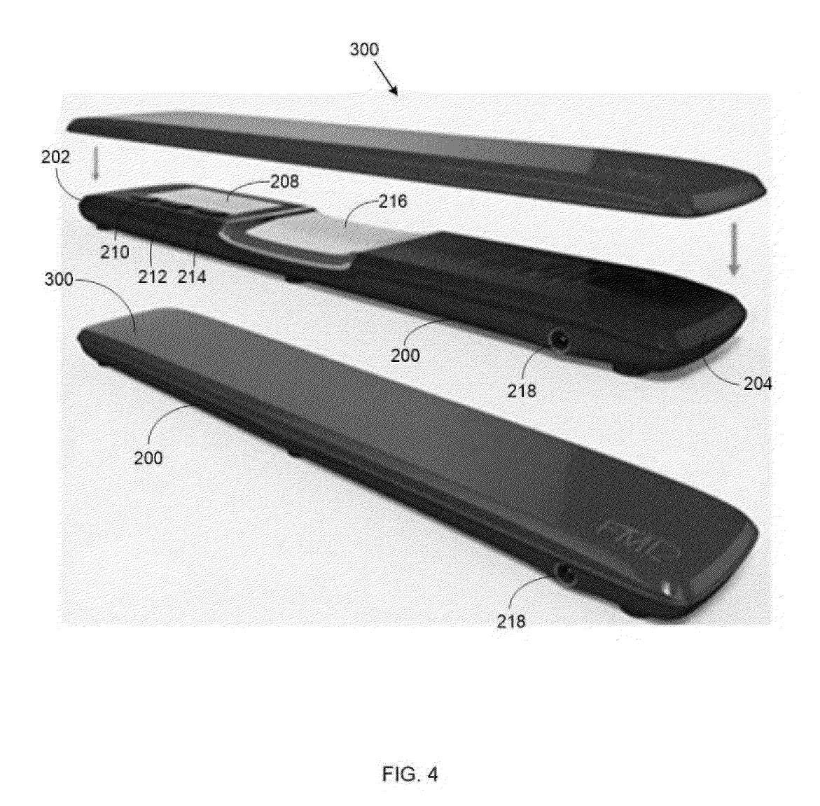

FIG. 4 illustrates a perspective view of the cap overlaying the weighing and tracking device to provide protection. In one aspect, the cap forms a protective surface for the device. Those skilled in the art will recognize that during travel, a container, such as luggage encounters physical forces form baggage handlers, stowage units, and conveyer belts. In some embodiments, the cap is shaped similar to the unit. The cap features a thin inward protruding lip around its lower perimeter that clips into a slit on that runs along the sidewall of the device. In this manner, the cap clips into place and can be popped off when needed. Thus, the cap protects the switches, display portion, scale and overall device while the device is joined with the container during transport. Suitable materials for the cap may include, without limitation, polyvinyl chloride (PVC), a rigid polymer, rubber, and metal.

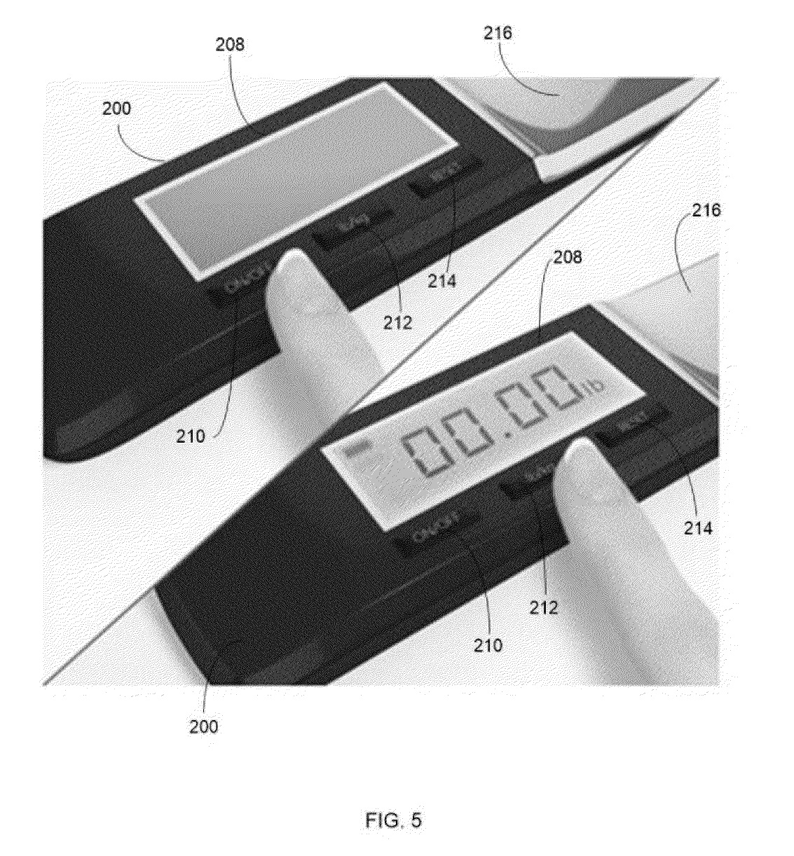

FIG. 5 illustrates a close-up view of an exemplary display portion displaying weight and an exemplary power switch, unit switch, and calibration switch. In one aspect, a digital readout of the weight displays on a display portion. The display portion may include, without limitation, an LCD screen, a digital interface, a touchscreen, and a digital display. The display portion may include a digital screen. The digital screen displays the weight until the user depresses the calibration switch to reset the weight to zero. This ensures the user can read the weight after the container has been detached from the device during the weighing process. This is advantageous over prior art situations in which, once the weight of the container is removed from secondary scales, such as an airport scale, the weight display disappears, thereby making it difficult for a single user to weigh the container and read the weight at the same time. The device defeats that difficulty.

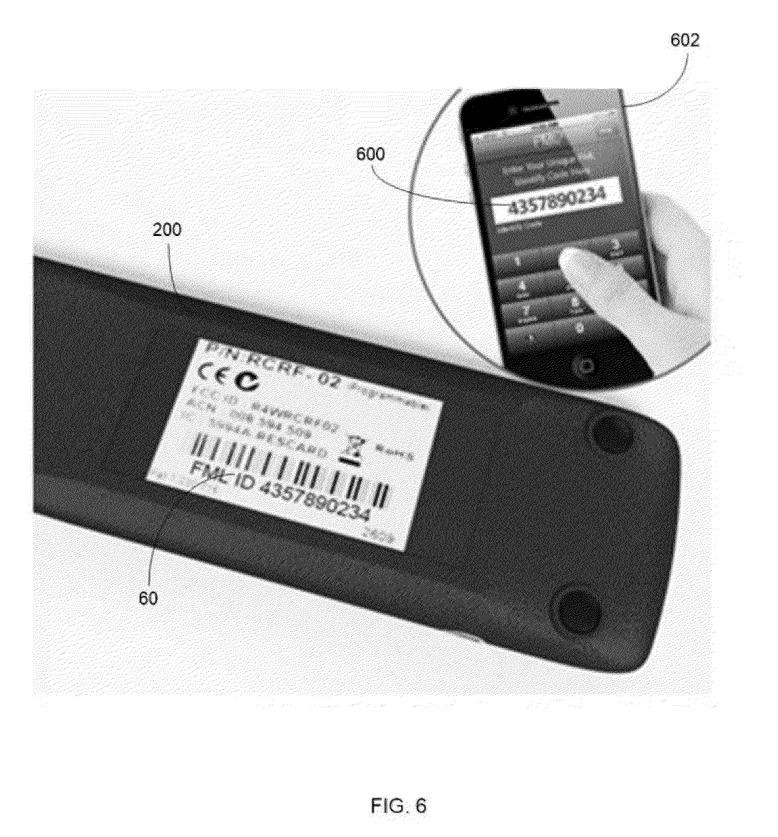

FIG. 6 illustrates a close-up view of an exemplary device identification code being programmed into an exemplary communication device. In one aspect, the device may utilize application software that is downloadable to a communication device 602, such as a smartphone. In some embodiments, the device may be tracked through both an indoor tracking system and an outdoor tracking system. In some embodiments, the device may include a unique device identification code 600 that must be programmed into the software application app identification code. The device identification code ensures that the software application is only in communication with the user's actual device, or multiple devices, so as not to confuse tracking with other devices or tracking systems.

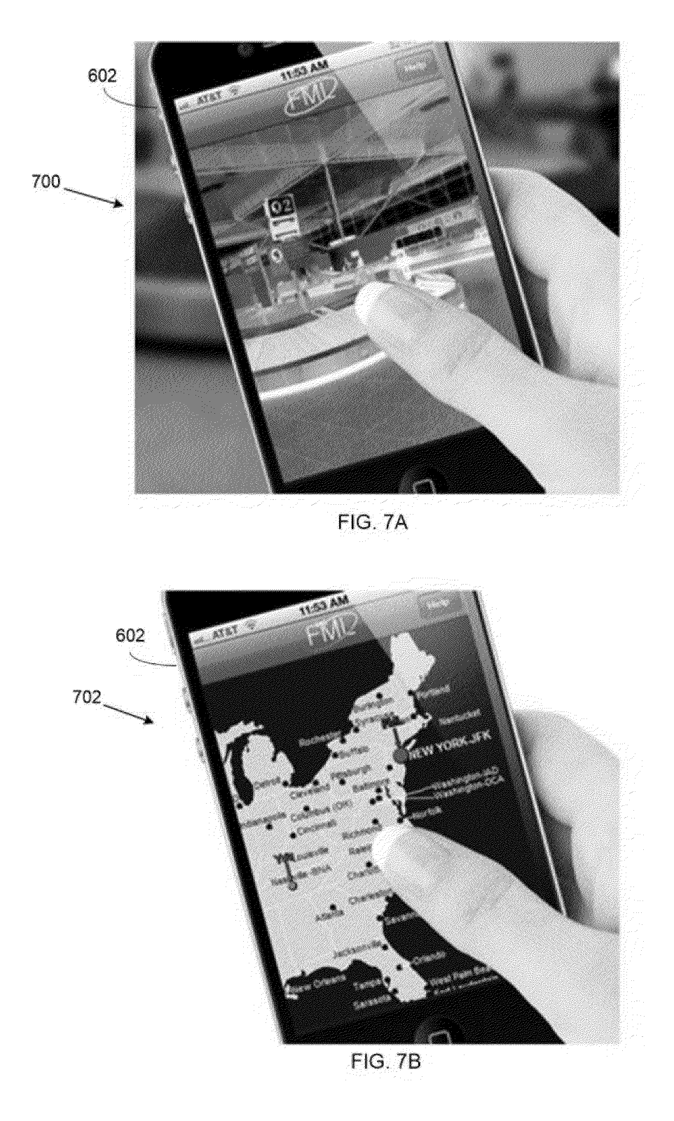

FIGS. 7A and 7B illustrate perspective views of the device tracking the container, where FIG. 7A illustrates an exemplary indoor tracking system, and FIG. 7B illustrates an exemplary outdoor tracking system. In one aspect, the device may be tracked through both an indoor tracking system 700 and an outdoor tracking system 702.

In some embodiments, a tracking unit may be disposed in the interior region of the housing. The tracking unit may include an apparatus that uses a Global Positioning System (GPS) to determine the precise location of the device, in which it is attached, and to record the position of the device at regular intervals. In this manner, the recorded location data can be stored within the tracking unit, or it may be transmitted to a central location data base, or internet-connected computer, using a cellular (GPRS or SMS), radio, or satellite modem embedded in the tracking unit. In some embodiments, tracking unit may include a transmitter that broadcasts in HS-GPS, VIC and RTLS via multiple location-based services.

In some embodiments, the device may be tracked through both an indoor tracking system and an outdoor tracking system. In some embodiments, the device may include a unique device identification code that must be programmed into the software application identification code. The device identification code ensures that the software application is only in communication with the user's actual device, or multiple devices, so as not to confuse tracking with other devices or tracking systems.

Consequently, the location of the device, and consequently the container, may be displayed against a map backdrop either in real time, or when analyzing the track later, using GPS tracking software on a communication device. The device may utilize application software that is downloadable to a communication device, such as a smartphone. In one embodiment, a mobile application software program may be downloaded to transmit container location directly to a communication device used by the user, allowing them to keep track of its precise whereabouts.

In the packaging of the device, instructions may be located to access and download the application software. With those directions will be the device identification code that is specific to the device in the package. The user may have to enter that device identification code into the software application, as shown in FIG. 6, to register the device with the software application.

The device may incorporate the latest in GPS technology. Standard GPS systems will not give the precise location of “tracked articles” when the articles are indoors. In one possible embodiment, a company named Broadcom Corp™ makes a Vertical Indoor Chip™, and another company named Guardly's™ makes an Indoor Position System™. These technologies can track the precise location of an item. These technologies are sufficiently precise, so as to locate items indoors and lead you to the “tracked item” even if it's on the 3^{rd} floor in a broom closet.

Consequently, the tracking unit may include one or both of these technologies. However if these new technologies will not function as standard GPS than the product will need a GPS as well, that way if the container is in a vehicle, the user can track it. The device may include at least one of the new indoor technologies and may incorporate both new technologies with existing GPS technology to accomplish tracking functions.

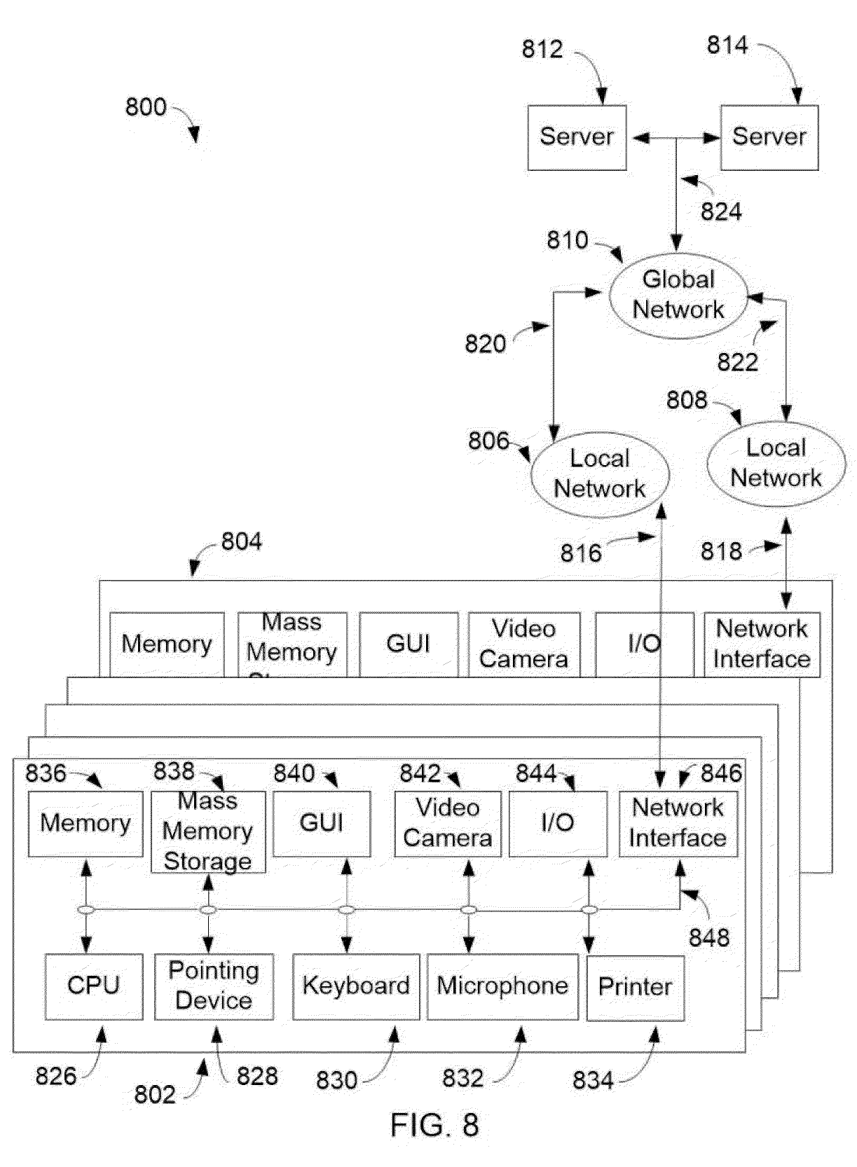

FIG. 8 illustrates a block diagram depicting an exemplary client/server system which may be used by an exemplary web-enabled/networked embodiment of the present invention. In one aspect, a communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, personal digital assistants (PDAs), cellular phones and smartphones.

Client 802 includes a CPU 826, a pointing device 828, a keyboard 830, a microphone 832, a printer 834, a memory 836, a mass memory storage 838, a GUI 840, a video camera 842, an input/output interface 844 and a network interface 846.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 836 is used typically to transfer data and instructions to CPU 826 in a bi-directional manner Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 830. Keyboard 830 enables a user with the capability to input alphanumeric textual information to CPU 826. CPU 826 may be coupled to microphone 832. Microphone 832 enables audio produced by a user to be recorded, processed and communicated by CPU 826. CPU 826 may be connected to printer 834. Printer 834 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a weighing and tracking device that detachably joins a container for weighing and tracking according to the present invention will be apparent to those skilled in the art. Various aspects of the invention have been described above by way of illustration, and the specific embodiments disclosed are not intended to limit the invention to the particular forms disclosed. The particular implementation of the weighing and tracking device that detachably joins a container for weighing and tracking may vary depending upon the particular context or application. By way of example, and not limitation, the weighing and tracking device that detachably joins a container for weighing and tracking described in the foregoing were principally directed to an elongated housing with a central scale for supporting and weighing luggage, and an internal tracking unit for tracking the luggage implementations; however, similar techniques may instead be applied to floatation devices, whereby air bladders can be used alongside the water bladders, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
a housing, said housing comprising a first end, a second end, a central region, an outer surface, and an interior region, said housing being configured to enable detachable attachment with a container, said housing further being configured to enable support of said container;
a depression, said depression being disposed on said central region, said depression being configured to enable balancing said supported container;
a scale, said scale being disposed in said interior region and substantially beneath said depression, said scale being configured to enable weighing said supported container;
a tracking unit, said tracking unit being configured to enable tracking of said container;
a power switch, said power switch being configured to power on and off said scale and said tracking unit;
a unit switch, said unit switch being configured to selectively alternate weight units;
a calibration switch, said calibration switch being configured to reset said weight;
a device identification code, said device identification code being disposed to integrate into said device, said device identification code being operable to identify said device; and
wherein said device is configured to be operable to communicate said weight, said tracking, and said device identification code with a communication device.

2. The device of claim 1, wherein said housing is generally elongated.

3. The device of claim 2, wherein said housing is about 9 inches long, 1.5 inches wide, and ½ inches thick.

4. The device of claim 3, in which said first end comprises said power switch, said unit switch, and said calibration switch.

5. The device of claim 4, in which said first end comprises a display portion, said display portion configured to display said weight.

6. The device of claim 5, in which said display portion comprises a digital screen.

7. The device of claim 6, wherein said first end and said second end are configured to enable gripping with both hands for supporting the weight of said container.

8. The device of claim 7, in which said scale comprises a digital balance scale.

9. The device of claim 8, wherein said depression is recessed about ¼ inches.

10. The device of claim 9, in which said device comprises a cap, said cap being configured to at least partially encapsulate said housing.

11. The device of claim 10, wherein said cap is substantially the same length as said housing.

12. The device of claim 11, in which device comprises a rechargeable power source, said rechargeable power source being configured to power said scale and said tracking unit.

13. The device of claim 12, in which said device comprises a port, said port being configured to receive a power cable.

14. The device of claim 13, wherein said tracking unit is operable with an outdoor tracking system through a global positioning system.

15. The device of claim 14, wherein said tracking unit is operable with an indoor tracking system through an indoor positioning system.

16. The device of claim 15, in which said communication device is a smartphone.

17. The device of claim 16, wherein said communication device is configured to download a tracking software application.

18. The device of claim 17, in which said container is luggage.

19. A device comprising:
means for joining a weighing and tracking means with a containing means;
means for centering said containing means on said weighing and tracking means;
means for weighing said containing means;
means for tracking said containing means;
means for identifying said weighing and tracking means to be unique to said containing means; and
means for monitoring said tracking means of said containing means.

20. A device consisting of:
a housing, said housing comprising a first end, a second end, a central region, an outer surface, and an interior region, said housing being configured to enable detachable attachment with a luggage, said housing further being configured to enable support of said luggage, said housing being configured at about 9 inches long, 1.5 inches wide, and ½ inches thick;
a cap, said cap being configured to at least partially encapsulate said housing;
a depression, said depression being disposed on said central region, said depression being configured to enable balancing said supported luggage, said depression being configured at about ¼ inches deep;
a scale, said scale being disposed in said interior region and substantially beneath said depression, said scale being configured to enable weighing said supported luggage, said scale comprising a digital balance scale;
a tracking unit, said tracking unit being configured to enable tracking of said luggage, said tracking unit being operable with an outdoor tracking system through a global positioning system, said tracking unit further being operable with an indoor tracking system through an indoor positioning system;
a rechargeable power source, said rechargeable power source being configured to power said scale and said tracking unit;
a port, said port being configured to receive a power cable;
a power switch, said power switch being configured to power on and off said scale and said tracking unit;
a unit switch, said unit switch being configured to selectively alternate weight units;
a calibration switch, said calibration switch being configured to reset said weight;
a device identification code, said device identification code being disposed to integrate into said device, said device identification code being operable to identify said device; and
wherein said device is configured to be operable to communicate said weight, said tracking, and said device identification code with a communication device.
